(19) United States
(12) Patent Application Publication
(10) Pub. No.: US 2005/0084201 A1
(43) Pub. Date: Apr. 21, 2005

(54) Optical bench for mounting optical element and manufacturing method thereof

(75) Inventors: Teruhisa Akashi, Moriya (JP); Satoshi Higashiyama, Hitachinaka (JP); Hideaki Takemori, Hitachinaka (JP); Kazuhiro Hirose, Hitachinaka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/880,956

(22) Filed: Jun. 29, 2004

(30) Foreign Application Priority Data
Oct. 17, 2003 (JP) 2003-357166

(51) Int. Cl. G02B 6/12; G02B 6/26; G02B 6/42

(52) U.S. Cl. 385/14; 385/15; 385/31; 385/33

(57) ABSTRACT

An optical bench for mounting an optical element includes a silicon substrate, a first dielectric substrate and a second dielectric substrate which are arranged on the silicon substrate, on the first substrate, there are arranged mounting sections of a laser diode, a wiring, and a mounting section of the photodiode, and on the silicon substrate, there is arranged a mounting section of a lens or an optical fiber, obtaining an optical bench, which is not easily curved with temperature, for mounting an optical element.

### BACKGROUND OF THE INVENTION

1. Field of the Invention

The present invention relates to an optical device mounting an optical element.

2. Description of the Related Art

Conventionally, JP-A-2002-50821 discloses an optical bench for mounting an optical element. It performs optical coupling between an optical semiconductor element consisting of a laser diode and a photodiode and an optical fiber or a lens, and makes it possible to transmit a high-frequency signal of 10 GHz as the maximum frequency signal frequency.

However, the aforementioned optical bench for mounting an optical element disclosed in the conventional example can be insufficient in the following points. In a high-frequency signal such as a signal having a frequency of over 10 GHz, the transmission loss cannot be suppressed sufficiently. The dielectric layer having a maximum film thickness of 10 μm (for example, composed of SiO₂) is not sufficient in thickness and cannot easily form a transmission path, i.e., a thin-film wiring pattern suppressing the transmission loss (for example, 3 dB/cm or below). Moreover, the silicon substrate should be a special substrate having a resistance of 10000 Ωcm. Moreover, in order to manufacture a non-dope silicon substrate to achieve this resistance, control of the resistance is very difficult. Moreover, it is difficult to define 10000 Ωcm or above. Furthermore, since a substrate with a special resistance is used, it is difficult to increase the productivity and reduce the cost.

Moreover, since the dielectric layer is formed on the entire surface of the silicon substrate, a dielectric layer of about 10 μm is formed in the V-shaped groove for the optical fiber. Accordingly, this dielectric layer easily lowers the groove accuracy of the V-shaped groove, which is formed by an anisotropic etching of silicon with a high accuracy. As a result, it is not easy to improve the accuracy of mounting the optical fiber (passive alignment accuracy).

### BRIEF SUMMARY OF THE INVENTION

It is therefore an object of the present invention to provide an optical bench, which solves at least one of the aforementioned problems, for mounting an optical element.

In order to achieve the aforementioned object, the present invention uses means as follows.

An optical bench for mounting an optical element includes a first substrate having a lens or optical fiber mounting section and a second substrate having a wiring layer having a portion mounting for a laser diode formed on the first main surface of the first substrate and optically coupled to the lens or the optical fiber and a coupling portion for electrically coupling to the laser diode.

More preferably, the present invention has the following configuration.

(1) An optical bench for mounting an optical element comprising:
a first substrate including a lens or optical fiber mounting section, and
a second substrate formed on the main surface of the first substrate, including a wiring layer having a mounting section of a laser diode optically coupled to the lens or the optical fiber and a coupling section for electrically coupling to the laser diode, and having a higher resistivity than the first substrate.

It should be noted that the second substrate may be a substrate having higher electric resistivity than the first substrate.

The second substrate has an opening at the region corresponding to the lens mounting section of the first substrate.

Alternatively, the end of the second substrate is positioned around the lens mounting section.

The first substrate is a silicon substrate. The second substrate is glass substrate.

With these forms, it is possible to provide an optical bench for, which can achieve at least one of the aforementioned objects, for mounting an optical element. Moreover, it is possible to constitute a device compatible with a high-frequency signal (for example, it is possible to suppress/reduce the transmission loss of a high-frequency signal of 10 GHz or above). Moreover, the transmission loss can reduce the dependency of the silicon substrate on the resistivity and there is provided a structure capable of using a general-purpose silicon substrate. Furthermore, it is possible to obtain a high accuracy of the V-shaped groove for mounting an optical fiber and a lens. Simultaneously with this, it is possible to obtain a structure causing no curve of the substrate and in particular, suppressing increase in the curve of the substrate according to the temperature change. That is, it is possible to provide a structure for suppressing increase in a loss of the optical coupling between the laser diode and the optical fiber.

(2) An optical bench for mounting an optical element comprising: a first substrate including a lens mounting section, a second substrate formed to opposite to one main surface of the first substrate and including a laser diode mounting section and a wiring layer coupled to the laser diode, and a third substrate formed on another main surface which is the opposite side of the aforementioned one main surface of the first substrate.

For example, as compared to the case when the other substrate formed on the first substrate is formed only one surface of the first substrate, it is possible to suppress curve of the substrate caused by the temperature change. The aforementioned other substrate may be, for example, a dielectric substrate. As a result, when the laser diode and the optical fiber are mounted on the aforementioned substrate, it is possible to suppress shift of the optical coupling and suppress increase in the coupling loss.

More preferably, an optical bench for mounting an optical element comprises: a first substrate including a lens or optical fiber mounting section; a second substrate, formed opposite to one main surface of the first substrate, including a laser diode mounting section optically-coupled to the lens or the optical fiber and a wiring layer coupled to the laser diode, and having a higher resistivity than the first substrate; and a third substrate formed on another main surface which is the opposite side of the aforementioned one main surface of the first substrate and having a higher resistivity than the first substrate.

Moreover, for example, the difference between the coefficient of thermal expansion of the second substrate and the third substrate is smaller than the difference between the coefficient of thermal expansion of the second substrate and that of the first substrate.

Moreover, for example, the second substrate is characterized in that there is provided an opening in the region corresponding to the lens mounting section of the first substrate. Alternatively, the end of the second substrate is positioned around the lens mounting section. Moreover, the third substrate has a greater area than the second substrate.

Moreover, for example, the third substrate is a glass substrate. As an embodiment, the second substrate and the third substrate may be dielectric substrate made from the same material.

As will be detailed later, when the second substrate or the third substrate is provided, it is preferable that the second substrate or the third substrate and more preferably both of the second substrate and the third substrate are formed to be thinner than the first substrate. Alternatively, under the other condition, when the second substrate or the third substrate is provided, it is preferable that the second substrate or the third substrate and more preferably both of the second and the third substrate are formed to be thicker than the first substrate.

Moreover, it is preferable that the difference of the thickness between the second substrate and the third substrate is smaller than that between the second substrate and the first substrate. As an example, the difference may be identical within the range of the measurement error.

Moreover, for example, the optical bench for mounting an optical element includes a wiring electrically connected to the laser diode, a mounting section for a lens or an optical fiber optically coupled to the laser diode, a mounting section for a photodiode optically coupled to the laser diode, and a mounting section for arranging a wiring electrically connected to the photodiode. For example, there are provided a first substrate which is a silicon substrate, a second substrate arranged on one main surface of the first substrate, and a third substrate arranged on the rear surface of the one main surface of the first substrate. On the second substrate, there are arranged the laser diode mounting section, the wiring, and the photodiode mounting section. On the first substrate, there is arranged the mounting section for the lens or the optical fiber.

Moreover, for example, a thin film is formed on the surface of the first substrate at the side of the second substrate. For example, the film is an oxide film formed from a substrate component reacted with oxygen around. Moreover, for example, a thin film is formed on the surface of the first substrate at the side of the third substrate. This film also may be an oxide film.

(3) An optical bench for mounting an optical element comprises:
a first substrate including a lens mounting section,
a laser diode mounting substrate formed in a first region on one main surface of the first substrate, including a laser diode mounting section and a first wiring layer electrically coupled to the laser diode, and having a higher resistivity than that of the first substrate, and
a photodiode mounting substrate formed in a second region on the one main surface of the first substrate, including a photodiode mounting section and a second wiring layer electrically coupled to the photodiode, and having a higher resistivity than that of the first substrate.

The lens mounting section may also be an optical fiber mounting section.

For example, the laser diode mounting substrate and the photodiode mounting substrate preferably have at least some states in the explanation about the second substrate. For example, these substrates are preferably made from the same main material. More preferably, they are made from the same material within the manufacturing error or measurement error.

(4) An optical bench for mounting an optical element comprising:
a laser diode mounting substrate including a laser diode mounting section and a first wiring layer electrically coupled to the laser diode, and having a higher resistivity than that of a first substrate,
a first underlayer substrate which is formed on a surface opposite to the surface where the laser diode mounting section on the laser diode mounting substrate is formed and which includes a lens mounting section optically coupled to the laser diode,
a photodiode mounting substrate including a photodiode mounting section and a second wiring layer electrically coupled to the photodiode, and having a higher resistivity than that of the first substrate, and
a second underlayer substrate which is formed on a surface opposite to the surface where the photodiode mounting section is formed on the photodiode mounting substrate.

(5) A manufacturing method of the aforementioned optical bench for mounting an optical element comprises the steps of:
forming a groove in a region where a lens or an optical fiber is arranged on one main surface of a first substrate, as a groove formation step, bonding a second substrate onto the main surface of the first substrate where the groove is formed, as a junction step,
forming an electrode film for electrically coupling to the laser diode on another main surface opposite to the bonded main surface of the second substrate and a wiring layer electrically coupled to the electrode film so that a wiring from outside is electrically coupled, as a conductor film formation step,
covering the film formed in the conductor film formation step with resist, as a resist formation step and
patterning the resist to form an opening in a region corresponding to the groove formation region of the second substrate, as an opening formation step.

By forming the opening, the second substrate covering the groove region is removed and the area of the second substrate is smaller than that of the first substrate.

Alternatively, the method for manufacturing an optical bench for mounting an optical element including a mounting section for a laser diode, a wiring electrically connected to the laser diode, a lens or an optical fiber optically coupled to the laser diode, a photodiode mounting section optically coupled to the laser diode, and a wiring electrically connected to the photodiode is characterized by comprising the steps of: forming a groove by anisotropic etching of the silicon substrate, bonding the silicon substrate to the first substrate and the second substrate, forming the laser diode mounting section, the wiring, and the photodiode mounting section on the first substrate, and etching a part of the first substrate so as to expose the groove formed on the silicon substrate.

The optical bench on which the optical element is mounted by using the aforementioned optical bench includes a first substrate, a second substrate arranged on one main surface of the first substrate, and a third substrate arranged on the rear surface of the main surface of the first substrate. On the second substrate, there are arranged a laser diode, a wiring electrically connected to the laser diode, a photodiode optically coupled to the laser diode, and a wiring electrically connected to the photodiode. On the first substrate, there is arranged a lens or an optical fiber optically coupled to the laser diode.

These optical bench for mounting an optical element can solve at least one of the aforementioned problems.

Alternatively, even if the transmission signal has high frequency (such as 10 GHz or above), it is possible to easily form a transmission line suppressing a loss.

Alternatively, by using the silicon substrate having a all-purpose resistvity, it is possible to obtain a high productivity and reduce the manufacturing cost.

Alternatively, since there is no need of forming a thick dielectric film in the etched groove for arranging the lens or the optical fiber, it is possible to maintain etched groove with high accuracy and maintain a high accuracy of mounting the lens or the optical fiber on the etched groove.

The optical bench for mounting an optical element of the present invention can solve at least one of the aforementioned problems.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a perspective view of an optical bench for mounting an optical element according to a first embodiment of the present invention.

FIG. 2 is an exploded perspective view of an optical bench for mounting an optical element shown in FIG. 1.

FIG. 3 is an exploded perspective view of an optical bench for mounting an optical element shown in FIG. 1 having a silicon substrate on whose surface is formed an etched groove for bonding.

FIG. 4 is an exploded perspective view of configuration showing an etched glass groove formed on the bonding surface of the first glass substrate and the second glass substrate.

FIG. 5 is a perspective view of an optical bench for mounting an optical element having configuration in which the first glass substrate has a stepped portion.

FIG. 6 is a perspective view of an optical bench for mounting an optical element according to a third embodiment of the present invention.

FIG. 7 is a perspective view of an optical bench for mounting an optical element according to a fourth embodiment of the present invention.

FIG. 8 is a perspective view showing a mounting configuration of a fourth glass substrate on which a photodiode is mounted.

FIG. 9 is a process flow showing a manufacturing process of an optical bench for mounting an optical element shown in FIG. 1.

FIG. 10 is a perspective view of an optical bench for mounting an optical element of the present invention on which a laser diode, a photodiode, and a ball lens are mounted.

FIG. 11 schematically shows the upper surface of laser diode module on which the optical bench for mounting an optical element as shown in the present invention is mounted.

### DETAILED DESCRIPTION OF THE INVENTION

Description will now be directed to the embodiments of the present invention with reference to the attached drawings.

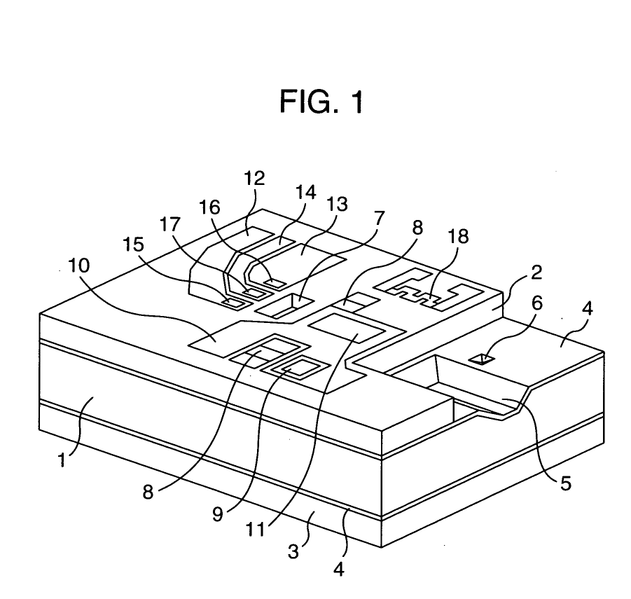

FIG. 1 is a perspective view of an optical bench for mounting an optical element according to a first embodiment of the present invention. The optical bench for mounting an optical element includes a silicon substrate 1 which is a semiconductor substrate as an example of the first substrate, a first glass substrate 2 as an example of the second substrate formed on the first main surface of the first substrate, and a second glass substrate 3 as an example of the third substrate formed on the opposite side of the first main surface of the first substrate. In this example, the silicon substrate 1 is thicker than the first glass substrate 2 and the second glass substrate 3. Moreover, the first glass substrate 2 and the second glass substrate 3 are dielectric substrates having substantially identical thickness. The difference between resistivity of the second substrate and that of the first substrate is smaller than the difference between resistivity of the second substrate and that of the third substrate. For example, these substrates are made from the same material, i.e., glass, within the range of the manufacturing error or measurement error. These dielectric substrates can be insulative substrates having a higher resistivity (Ω/cm) than that of the silicon substrate 1 as a semiconductor substrate. Moreover, for example, the silicon substrate 1 is bonded to the first glass substrate 2 via an oxide film 4 such as an SiO₂ thin film which is a natural oxide film or a thermal oxide film, and the silicon substrate 1 is bonded to the second glass substrate 3 via the oxide film 4, i.e., the SiO₂ thin film. The first glass substrate 2 and the second glass substrate 3 are located on the SiO₂ thin film of the oxide film 4. The silicon substrate 1 is preferably a single crystal silicon substrate having the (100)—oriented plane as the main surface. Moreover, for example, on its surface, the oxide film 4, i.e., the SiO₂ thin film is formed and partially, an etched groove 5 and an inverse pyramid groove 6 are formed by an anisotropic etching of silicon. The inverse pyramid groove 6 is formed line-symmetrically along the center line of the etched groove 5 in the vicinity of the etched groove 5. On the surface of the first glass substrate 2, there are formed a tantalum nitride thin film resistor 8, a tantalum oxide thin film capacitor 9, a laser diode common thin film electrode 10 for electrical connection with the laser diode, an AuSn solder thin film for the laser diode 11 which is a solder film for mounting the laser diode and formed on the laser diode common thin film electrode 10, a photodiode thin film electrode 14 for electrical connection with the photodiode, a photodiode first common thin film electrode 12, a photodiode second common thin film electrode 13, a photodiode first AuSn solder thin film 17 which is a solder film for mounting the photodiode and formed on the photodiode thin film electrode 14, a photodiode second AuSn solder thin film 15 which is a solder film for mounting the photodiode and formed on the photodiode first common thin film electrode 12, a photodiode third AuSn solder thin film 16 which is a solder film for mounting the photodiode and formed on the photodiode common thin-film electrode 13, a thin-film temperature sensor 18 for measuring surface temperature of the substrate when the laser diode is operating, and an etched glass etching groove 7 for reflecting the emitted light from the laser diode and introducing the light into the photodiode.

As shown in the figure, the tantalum nitride thin-film resistor 8 and tantalum oxide thin-film capacitor 9 are formed in the vicinity of the position where the AuSn solder thin film, where the laser diode is mounted for the laser diode 11, is formed. The high-frequency electric signal exceeding 10 GHz transmitted to the laser diode and the photodiode is transmitted to the thin film elements such as the tantalum nitride thin-film resistor 8 and the laser diode common thin-film electrode 10. Furthermore, the etched groove 5 is a groove used for mounting the optical fiber and the lens. The inverse pyramid groove 6 can be used as a marker groove for deciding the position for mounting the optical fiber and the lens. For example, when a lens with cylindrical outer shape is mounted on the etched groove 5, the height fo the mounted lens, i.e., the position of optical axis of the lens is decided by the width of the etched groove 5. This is because the etched groove 5 is formed by the anisotropic etching of silicon and the side wall of the etched groove 5 is composed of the {111}-oriented plane of the silicon crystal surface. This is also because the {111}-oriented plane and the (100)-oriented bottom surface cross constantly at 54.7 degrees. Thus, since the angle at which the side wall and the bottom surface of the etched groove 5 cross is constant, the height in the center of the lens is decided by the width of the etched groove 5. Here, if the spot (exit for emitting light) of the laser diode mounted on the first glass substrate 2 via the AuSn solder thin film for the laser diode 11 coincides with the lens center, optical coupling can be obtained and the optical axes coincide. The width of the etched groove 5 may be calculated so that these optical axes coincide.

Moreover, positioning the lens in the longitudinal direction can be performed by using the inverse pyramid groove formed in the vicinity of the etched groove 5 as reference marker. It should be noted that the silicon substrate 1 may have any orientation if it expresses the {100}-oriented plane and the resistivity of the silicon substrate 1 may be any resistivity. Preferably, the resistivity is 1000 Ωcm or below. This is because the first glass substrate 2 transmitting a high-frequency signal of 10 GHz or above has a sufficiently large thickness as compared to the thin film formed by the sputtering method and the CVD (Chemical Vapor Deposition) method. Accordingly, it is possible to suppress the affect of the resistivity of the silicon substrate 1 as an underlayer substrate to the transmission characteristic of the high-frequency transmission path (electrode pattern) composed of the thin-film element on the first glass substrate 2.

The loss of the transmission path is divided into the conductor loss and the dielectric loss. In this embodiment, a transmission path composed of the thin-film element is formed on the first glass substrate 2 having a low dielectric loss and accordingly, the conductor loss is dominant. When a metal film having a large thickness is used as a transmission path, the conductor loss can almost be ignored. In this embodiment, thickness of the metal film can be easily made large and it is possible to reduce the loss of the transmission path.

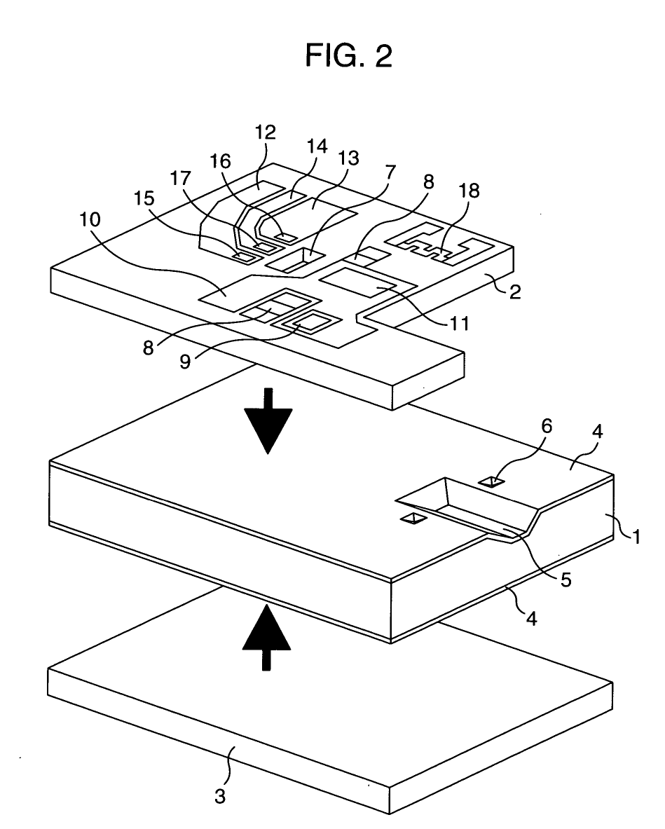

FIG. 2 is an example of an exploded perspective view of the optical bench for mounting an optical element shown in FIG. 1. The first glass substrate 2 and the second glass substrate 3 preferably have a coefficient of thermal expansion of 33×10−7/° C. which is near to the coefficient of thermal expansion (23.3×10−7/° C.) of the silicon substrate 1 and contain plenty of 4% Na₂ O inside (such as boronsilicate glass) which can be anodically bonded to the silicon substrate 1. For example, the resistivity is about 4×10¹⁴ Ωcm at 20° C. As shown in the figure, the etched groove 5 and the inverse pyramid groove 6 are formed by the anisotropic etching of silicon. On the silicon substrate 1 having the natural oxide film 4, i.e., an SiO₂ thin film formed on its surface, the first glass substrate 2 and the second glass substrate 3 are bonded by the anodic bonding. The first glass substrate 2 is bonded by anodic bonding to the first main surface of the silicon substrate 1 where the etched groove 5 and the inverse pyramid groove 6 are formed. The second glass substrate 3 is bonded by anodic bonding to the rear surface of the silicon substrate. The first glass substrate 2 should have such a shape that the etched groove 5 and the inverse pyramid 6 are not concealed by the silicon substrate 1 after bonding. The shape of the first glass substrate 2 shown in FIG. 2 is one example and may be any shape if it does not cover the etched groove 5 and the inverse pyramid groove 6. As shown in the figure, the first glass substrate 2 has a bonding surface whose area is smaller than the area of the surface of the silicon substrate 1. Alternatively, at least the etched groove has a region located outside the end portion of the first glass substrate 2. On the other hand, on the second glass substrate 3, no thin film element such as the tantalum nitride thin-film resistor 8 is formed. It can easily be formed with the width and the length identical to the width and the length of the silicon substrate 1. That is, the bonded area is preferably identical to the silicon substrate 1 and the second glass substrate 3. For example, the difference between the area of the second substrate and the area of the second glass substrate 3 which is a third substrate is smaller than the difference between the area of the silicon substrate 1 which is a first substrate and the first glass substrate 2 which is a second substrate. The first glass substrate 2 and the second glass substrate 3 may be processed into the shape as shown in FIG. 2 and then subjected to anodic bonding to the silicon substrate 1. However, it is preferable to perform firstly anodic bonding with a wafer level between the silicon wafer which has been subjected to anisotropic etching and the glass wafer and form a thin-film element such as the tantalum nitride thin-film resistor 8 before forming the etched glass groove 7 and the opening by dry etching. This structure of the embodiment is such that the silicon substrate 1 is sandwiched by the first glass substrate 2 and the second glass substrate 3 and accordingly, it is possible to suppress curve of the substrate by temperature change. For example, if the first glass substrate 2 and the second glass substrate 3 are formed from the same material, they have an identical coefficient of thermal expansion and the substrate expands only in the longitudinal direction and is substantially not curved by the temperature change.

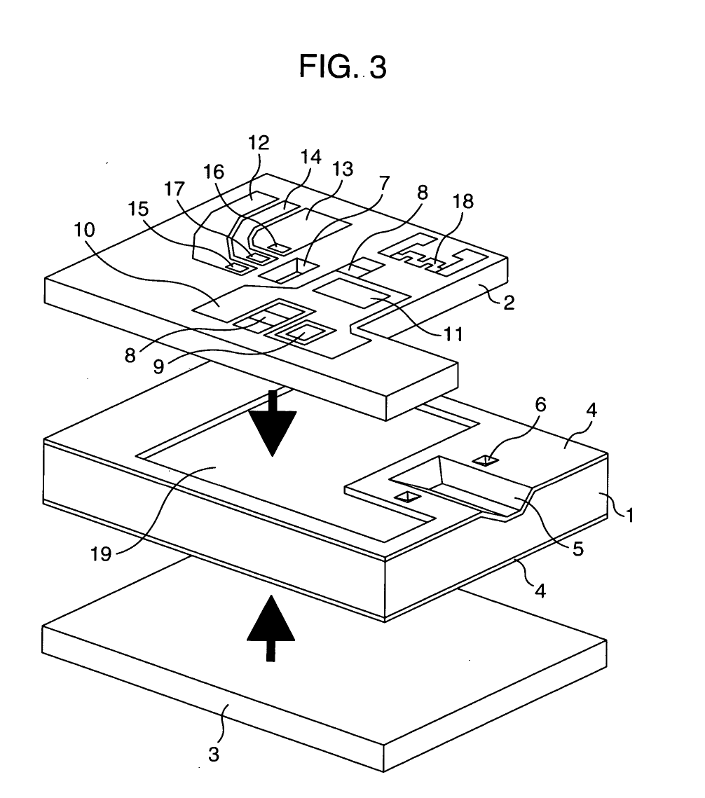

FIG. 3 is an example of an exploded perspective view of an optical bench for mounting an optical element of FIG. 1 using a bonding etched groove 19 formed on the surface of the silicon substrate 1. This has the same configuration as that of FIG. 2 except for that the bonding etched groove 19 is formed on the silicon substrate 1. When the bonding etched groove 19 is formed, the bonding area between the silicon substrate 1 and the first glass substrate 2 becomes small and the pressure applied upon bonding can be made small. Moreover, there is an advantage that curve of the substrate after bonding can be suppressed. By the same reason, the bonding etched groove is also formed on the rear surface of the silicon substrate 1.

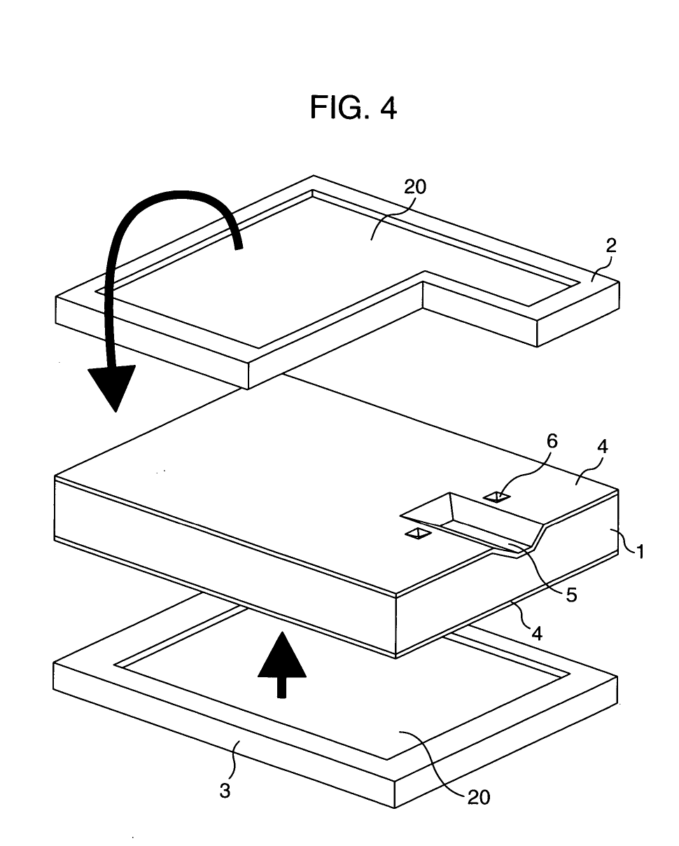

FIG. 4 shows another example in which the bonding etched glass groove 20 is formed on the bonding surface of the first glass substrate 2 and on the bonding surface of the second glass substrate 3 instead of the boding etched groove 19 formed on the front and rear surfaces of the silicon substrate 1. With this configuration, there is an advantage that it is also possible to reduce the pressure applied during bonding and suppress curve of the substrate after the bonding.

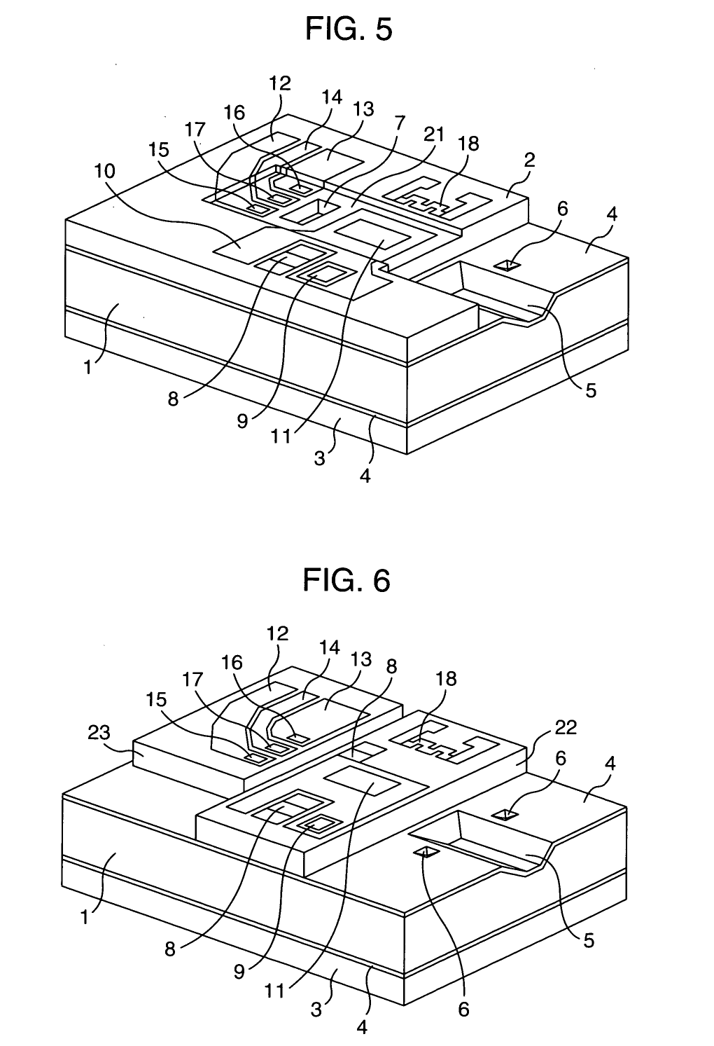

FIG. 5 is a perspective view of an optical bench for mounting an optical element showing an example in which the position for mounting a laser diode and the position for mounting a photodiode on the first glass substrate 2 which is a dielectric substrate are located at a position lower than the substrate surface of the first glass substrate 2. In order to locate the laser diode mounting position and the photodiode mounting position lower than the substrate surface of the first glass substrate 2, a height adjustment groove 21 is formed on the first glass substrate 2. The optical bench for mounting an optical element of the example of FIG. 5 has the same configuration as FIG. 1 except for that the height adjustment groove 21 is formed on the glass substrate 2.

The laser diode common thin-film electrode 10 for performing electrical connection with the laser diode is formed in the height adjustment groove 21 together with the surface of the first glass substrate 2. Similarly, the photodiode thin-film electrode 14 for performing electrical connection with the photodiode, the photodiode first common thin-film electrode 12, and the photodiode second common thin-film electrode 13 are formed in the height adjustment groove 21 together with the surface of the first glass substrate 2. Moreover, the laser diode AuSn solder thin film 11 which is a solder film for mounting the laser diode and the photodiode first AuSn solder thin film 17 which is a solder film for mounting the photodiode, the photodiode second AuSn solder thin film 15, and the photodiode third AuSn soldering thin film 16 are formed in the height adjustment groove 21. When mounting a lens having a cylindrical outer shape in the etched groove 5, if the height adjustment groove 21 is formed on the first glass substrate 2, the center of the lens can easily be matched with the spot of the laser diode as compared when the height in the center of the lens is adjusted only by the width of the etched groove 5. Here, explanation has been given on the case that the laser diode mounting position and the photodiode mounting position are located at a lower position than the substrate surface of the first glass substrate 2. On the contrary, these positions may be located at a higher position than the substrate surface of the first glass substrate 2.

Explanation will now given on a modified example of FIG. 1 as a second embodiment. It has basically the same configuration as FIG. 1. The first glass substrate 2 can have thickness greater than the silicon substrate 1 in the second embodiment. More preferably, the second glass substrate 3 also has thickness greater than the silicon substrate 1. The first glass substrate 2 and the second glass substrate 3 are dielectric substrates made from the same glass material and have almost identical thickness. Since these substrates are dielectric substrates, they are insulative substrate having a higher resistivity than that of the silicon substrate. A high-frequency electric signal of 10 GHz or above is transmitted to the laser diode and the photodiode via the thin-film element on the first glass substrate 2. As compared to the first embodiment shown in FIG. 1, the silicon substrate 1 has a thin thickness. However, since the thin-film element which is a transmission path according to the transmission signal of 10 GHz or above is formed on the first glass substrate, it is possible to transmit a signal with a low loss without deteriorating the transmission characteristic without depending on the resistivity of the silicon substrate 1.

FIG. 6 is a perspective view of an optical bench for mounting an optical element according to a third embodiment of the present invention. The optical bench for mounting an optical element consists of a silicon substrate 1, a second glass substrate 3, a third glass substrate 22, and a fourth glass substrate 23. In this case, the silicon substrate 1 have thickness greater than the second glass substrate 3, the third glass substrate 22, and the fourth glass substrate 23. On the contrary, the silicon substrate 1 may be a substrate having thickness smaller than these substrates. The second glass substrate 3, the third glass substrate 22, and the fourth glass substrate 23 are dielectric substrates having substantially identical thickness and made from the same glass material. Accordingly, as compared to the silicon substrate 1, these substrates have a high resistivity and a high conductance. The third glass substrate 22 and the fourth glass substrate 23 are bonded to the surface of the silicon substrate 1 via the natural oxide film 4, i.e., an SiO₂ thin film while the second glass substrate 3 is bonded to the rear surface of the silicon substrate 1 via the natural oxide film 4, i.e., an SiO₂ thin film.

That is, the second glass substrate 3, the third glass substrate 22, and the fourth glass substrate 23 are located on the SiO₂ thin film of the natural oxide film 4. One main surface of the silicon substrate 1 is a single crystal silicon substrate whose surface is (100)-oriented plane on which the natural oxide film 4 is formed. Partially, the etched groove 5 and the inverse pyramid groove 6 are formed by the anisotropic etching of silicon. The inverse pyramid groove 6 is formed in a line symmetry manner with respect to the center line of the etched groove 5 in the vicinity of the etched groove 5. The third glass substrate 22 and the fourth glass substrate 23 bonded to the silicon substrate 1 are separated. On the third glass substrate 22, there are formed a tantalum nitride thin-film resistor 8, a tantalum oxide thin-film capacitor 9, a laser diode common thin-film electrode 10 for performing electrical connection with the laser diode, a laser diode AuSn solder thin film 11 which is a solder film for mounting the laser diode, and a thin-film temperature sensor 18 for measuring the surface temperature of the substrate when the laser diode is operating. The laser diode is mounted on the third glass substrate 22 via the laser-diode AuSn solder thin film 11. Here, a high-frequency electric signal of 10 GHz or above is applied to the laser diode via the tantalum-nitride thin-film resistor 8 and the laser-diode common thin-film electrode 10. It should be noted that the silicon substrate may have any orientation if it expresses the {100}-oriented plane and the silicon substrate 1 may have any resistivity. This is because the third glass substrate 22 for transmitting the high-frequency signal has a sufficiently large thickness as compared to the thin film formed by the sputtering method and the CVD (Chemical Vapor Deposition) method. Accordingly, the resistivity of the silicon substrate 1 as an underlayer substrate does not affect the transmission characteristic of the high-frequency transmission path (electrode pattern) composed of the thin-film element on the third glass substrate 22. On the other hand, on the fourth glass substrate 23, there are formed a photodiode thin-film electrode 14 for performing electrical connection with the photodiode, a photodiode first common thin-film electrode 12, a photodiode second common thin-film electrode 13, a photodiode first AuSn solder thin film 17 which is a solder film for mounting the photodiode formed on the photodiode thin-film electrode 14, a photodiode second AuSn solder thin film 15 which is a solder film for mounting the photodiode formed on the photodiode first common thin-film electrode 12, and a photodiode third AuSn solder thin film 16 which is a solder film for mounting the photodiode formed on the photodiode common thin-film electrode 13. The photodiodes are mounted on the fourth glass substrate 23 via the respective AuSn solder thin films. Here, via the photodiode thin-film electrode 14 and the like, the high-frequency electrical signal transmitted from the photodiode is transmitted to the IC for signal processing arranged outside the optical bench for mounting an optical element without deteriorating the signal waveform.

In this case, the resistivity of the silicon substrate 1 can be ignored as a factor of deterioration of transmission characteristic of the transmission path formed on the fourth glass substrate 23. This is because the fourth glass substrate 23 for transmitting the high-frequency electric signal from the photodiode has a sufficiently large thickness as compared to the dielectric thin film and the resistivity of the silicon substrate 1 as an underlayer substrate does not affect the transmission characteristic of the high-frequency transmission path composed of the thin-film element on the fourth glass substrate 23.

Thus, even when the glass substrate for mounting the laser diode and the glass substrate for mounting the photodiode are separate substrates, this does not deteriorate the transmission characteristic of the high-frequency electric signal transmission. Moreover, in order to suppress the curve of the substrate and the curve of the substrate by the temperature change, it is preferable that a glass substrate formed from the same material for curve correction is bonded to the rear surface of the silicon substrate 1 like in the embodiments shown in FIG. 1 to FIG. 5. It should be noted that the second glass substrate 3 bonded to the rear surface of the silicon substrate 1 may have a bonding area on the silicon substrate 1 smaller than the area of the rear surface of the silicon substrate 1 and may be partially omitted. The second glass substrate 3 preferably has configuration so as to correct the substrate curve after the third glass substrate 22 and the fourth glass substrate 23 are bonded to the silicon substrate 1. For this, the second glass substrate 3 does not always need to have the substrate thickness substantially identical to the third glass substrate 22 and the fourth glass substrate 23.

An optical bench for mounting an optical element according to the fourth embodiment may have configuration of FIG. 1 from which the second glass substrate 3 is removed if the substrate curve can be suppressed by making the thickness of the silicon substrate 1 sufficiently large. Since the bonding area of the third glass substrate 22 and the fourth glass substrate 23 bonded to the silicon substrate 1 is small as compared to the structure of the first embodiment shown in FIG. 1, the substrate curve after the bonding is smaller than in the first embodiment of FIG. 1. The optical bench for mounting an optical element may have configuration in which the second glass plate 3 arranged in the aforementioned embodiment does not exist. However, as compared to the case of bonding of the second glass substrate 3 onto the rear surface of the silicon substrate 1, there is a danger that the substrate curve due to the temperature change becomes greater. However, there is no problem if the curve is within a range causing no problem for the element characteristic. The bonding area of the third glass substrate 22 and the fourth glass substrate 23 are made as small as possible and the thickness of these substrates is made small while the thickness of the silicon substrate 1 is made large, thereby reducing the substrate curve due to the temperature change. For this, it is possible to minimize the shift of the optical axis, due to temperature change, between the laser diode, the photodiode, and the lens mounted on the etched groove 5.

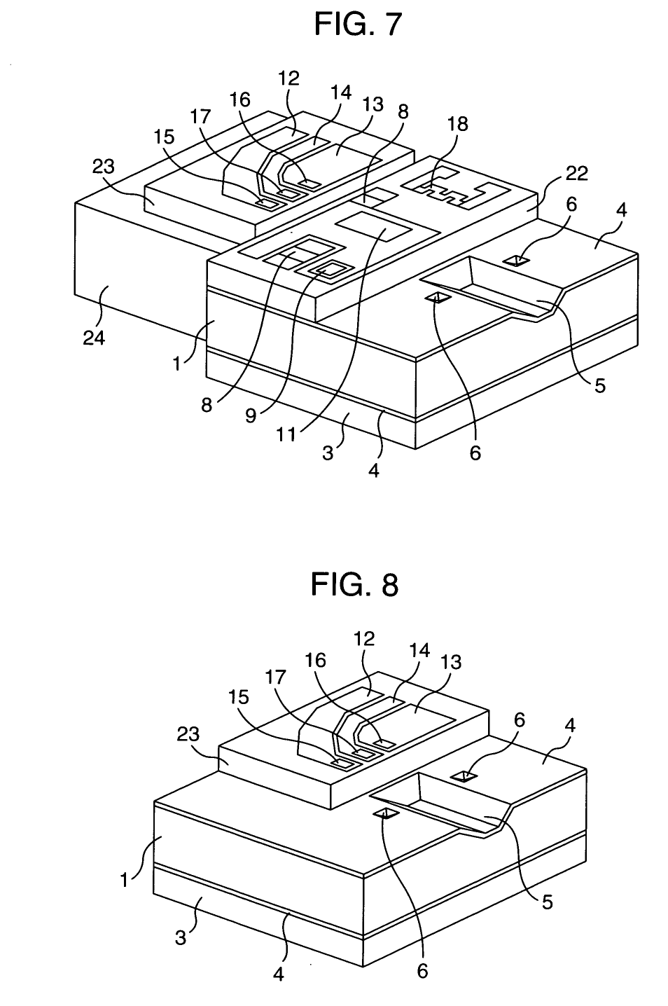

FIG. 7 is a perspective view of an optical bench for mounting an optical element according to a fifth embodiment of the present invention. As compared to the configuration shown in FIG. 6, the fourth glass substrate 23 does not exist and only the third glass substrate 22 is bonded onto the silicon substrate 1 via the natural oxide film 4, i.e., an SiO₂ thin film. The third glass substrate 22 is located on the SiO₂ thin film of the natural oxide film 4. The fourth glass substrate 23 as a substrate for mounting the photodiode is mounted on the base substrate 24 which is different from the silicon substrate 1 and arranged at a position for optical coupling with the laser diode. On the other hand, the laser diode mounted on the third glass substrate 22 via the laser-diode AuSn solder thin film 11 on the third glass substrate 22 has an optical axis of the laser diode matched with that of the lens mounted on the etched groove. With this configuration also, the high-frequency electric signal of 10 GHz or above can be transmitted on the glass substrates while suppressing deterioration of the transmission characteristic. Moreover, since the silicon substrate is sandwiched by glasses having substantially identical thickness, the shift of the optical axis due to temperature change can be suppressed. Moreover, by using a photodiode of the surface detecting photodiode having a large effective area for receiving light, it is possible to easily perform optical coupling with the laser diode even if the fourth glass substrate 23 is mounted on a substrate which is different from the silicon substrate 1. With this configuration also, it is possible to satisfy the desired characteristic.

The fourth glass substrate 23 which is a substrate for mounting the photodiode is mounted on the base substrate 24, which may be mounted on the silicon substrate 1 shown in FIG. 8. In this case, the fourth glass substrate 23 is bonded to the silicon substrate 1 which is different from the silicon substrate 1 where the third glass substrate 22 is mounted in FIG. 7, via the natural oxide film 8, i.e., an SiO₂ thin film. Naturally, the photodiode is mounted on the fourth glass substrate 23 via the photodiode first AuSn solder thin film 17, the photodiode second AuSn solder thin film 15, and the photodiode third AuSn solder thin film 16 on the fourth glass substrate 23. On the silicon substrate 1, the etched groove 5 and the inverse pyramid groove 6 are formed and at this position, a lens can be mounted. This configuration is preferable for optical coupling with the laser diode. After the photodiode and the lens are thus mounted, it is possible to easily match the laser diode mounted on the optical bench for mounting an optical element shown in FIG. 7 with the optical axis.

It should be noted that in any of the aforementioned embodiments, no thin film other than the natural oxide film 4 is formed in the etched groove 5 and the inverse pyramid groove 6 and accordingly, it is possible to maintain the structure, i.e., accuracy formed by the anisotropic etching of silicon.

Furthermore, the metal film constituting the transmission path composed of the thin film element is preferably a thick film having a film thickness of about 3 micrometers so as to reduce/suppress the conductor loss of the transmission path.

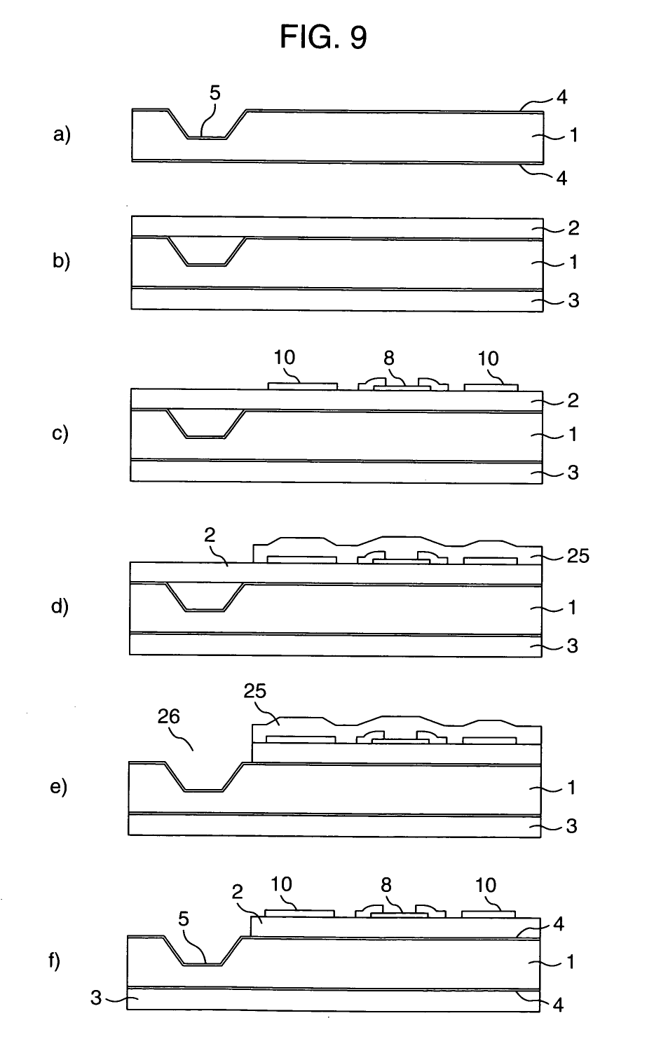

Next, explanation will be given on the method for manufacturing an optical bench for mounting an optical element having the structure shown in FIG. 1 with reference to FIG. 9. This manufacturing method is characterized in that a plurality of grooves with different shapes (different depths or different sizes) are formed on the silicon substrate by the anisotropic etching of silicon, after which a glass substrate is bonded to the silicon substrate and the thin-film elements such as the thin-film resistor and the thin-film electrode are formed on the glass substrate, which is then etched by the dry etching. Here, FIG. 9 is a cross sectional view for easily understanding a method for manufacturing the optical bench for mounting an optical element having a characteristic structure. Accordingly, it does not coincide with the cross sectional view of the optical bench for mounting an optical element shown in FIG. 1. The manufacturing method will be explained according to step (a) to step (f) in FIG. 9.

(a) Firstly, an Si₃N₄/SiO₂ layered film (not depicted) is formed on both sides of the silicon substrate 1 with the (100)-oriented surface. The SiO₂ film (for example, having a film thickness of 120 nm) is a thermal oxide film formed by thermal oxidization while the Si₃N₄ film (for example, having a film thickness of 160 nm) is formed by the low pressure CVD (Chemical Vapor Deposition). Next, an opening is arranged for forming the etched groove 5 and the inverse pyramid groove 6 on the Si₃N₄/SiO₂ layered film. This method uses the photo lithography used in the conventional semiconductor technology (resist coating, exposure, development, resist pattern formation, and pattern transfer onto the Si₂N₄/SiO₂ layered film using the resist as a masking material). The etching of the Si₃N₄/SiO₂ layered film uses the RIE (Reactive Ion Etching). After this, the anisotropic etching of silicon is performed by using aqueous solution of potassium hydroxide with a concentration of 40 wt % with a temperature of 70 degrees. Here, the etching is performed until a desired depth of the etched groove 5 such as 450 micrometers can be obtained. As for the inverse pyramid groove 6 (not depicted in FIG. 9), the mask opening on the Si₃N₄/SiO₂ layered film is small and the {111} plane appears and the V-shaped groove, i.e., the inverse pyramid form is obtained before the etching depth of the etched groove 5 reaches to 450 micrometers. It appears that the etching stops. Thus, formation of different types of grooves (grooves having different depths and different sizes) by the anisotropic etching of silicon is regulated by the etching of the deepest groove but a plurality of grooves can be formed simultaneously. Next, the Si₃N₄/SiO₂ layered film is successively removed of by using thermal phosphoric acid and BHF (aqueous solution of mixture of HF+NH₄F). After this, the silicon substrate 1 is placed in the atmosphere and the natural oxide film 4 is formed on the both surfaces of the silicon substrate 1.

(b) Next, the silicon substrate 1 is anodically bonded to the first glass substrate 2, which is a boronsilicate glass containing about 4% Na₂ O inside, having the coefficient of thermal expansion near to the silicon substrate 1. For example, the bonding can be performed under conditions: a substrate heating temperature of 400 degrees and an applied voltage of 600V. Furthermore, the first substrate 2, the second glass substrate 3 whose thickness is equal to the thickness of the first substrate 2, and the silicon substrate 1 are bonded by the same method. Here, the first glass substrate 2 and the second glass substrate 3 are layered on the silicon substrate 1 on the heater. Voltage is applied to the first glass substrate 2 so as to be bonded. Then, voltage is applied to the second glass substrate 3 so as to be bonded. By this method, it is possible to reduce the curve of the substrate due to bonding.

(c) On the first glass substrate 2, there are formed a tantalum-nitride thin-film resistor 8, a tantalum-oxide thin-film capacitor 9 (not depicted in FIG. 9), a laser-diode common thin-film electrode 10, a laser-diode AuSn solder thin film 11 (not depicted in FIG. 9), a photodiode thin-film electrode 14 (not depicted in FIG. 9), a photodiode first common thin-film electrode 12 (not depicted in FIG. 9), a photodiode second common thin-film electrode 13 (not depicted in FIG. 9), a photodiode first AuSn solder thin film 17 (not depicted in FIG. 9), a photodiode second AuSn solder thin film 15 (not depicted in FIG. 9), a photodiode third AuSn solder thin film 16 (not depicted in FIG. 9), and a thin-film temperature sensor 18 (not depicted in FIG. 9). Firstly, an Au (for example, film thickness: 3 micrometers))/Pt (for example, film thickness: 300 nm)/Ti (for example, film thickness: 100 nm) thin film (not depicted) is formed. The film is formed by using the sputtering method or the vacuum evaporation method. In this case, other metal films can also be used such as a single layer film of an Al thin film or a Cr thin film. It is preferable that the outermost metal films have a sufficient film thickness of about 3 micrometers so as to reduce/suppress the conductor loss of the transmission path composed of the thin-film pattern. Next, a resist pattern is formed by the photo lithography and this is used as a masking material for etching the Au/Pt/Ti thin film by ion milling. After this, the resist is removed by using a remover and oxygen ashing, thereby forming the laser diode common thin-film electrode 10, the photodiode thin-film electrode 14, the photodiode first common thin-film electrode 12, and the photodiode second common thin-film electrode 13. Next, the lift-off method is used to form the tantalum-nitride thin film, the tantalum-oxide thin film, the upper Au/Pt/Ti thin film for the thin-film capacitor, and the Pt/Ti thin film for the thin-film temperature sensor. Here, the tantalum-nitride thin film and the tantalum-oxide thin film can be formed by the sputtering method. The sputtering method in this case may be the reactive sputtering method for introducing a small amount of nitrogen gas into the argon atmosphere for film deposition of the former and the reactive sputtering method for introducing oxygen gas into the argon atmosphere for film deposition of the latter. The Pt/Ti thin film can be formed by using the sputtering method or the vacuum evaporation. Thus, the respective thin-film elements are formed on the first glass substrate 2.

(d) For example, a negative-type resist having a viscosity as high as 1000 cp is coated on the first glass substrate 2 and a thick resist film pattern 25 is obtained by the photo lithography. The thickness of the thick resist film pattern 25 is about 100 micrometers for example. Here, it is preferable to simultaneously form a resist opening for forming an etched glass groove (not depicted in FIG. 9).

(e) By dry etching of glass by using the ICP (Inductively Coupled Plasma), an etched opening 26 and an etched glass groove 7 are formed on the first glass substrate 2.

(f) The thick resist film pattern 25 is removed by using the oxygen ashing and the remove. Next, positive-type resist (not depicted) is coated on the substrate surface by the spray coating method. After this, a resist pattern (not depicted) is formed by the photo lithography. The resist pattern formed here is a resist pattern compatible with the laser diode AuSn solder thin film 11 (not depicted in FIG. 9), the photodiode first AuSn solder thin film 17 (not depicted in FIG. 9), the photodiode second AuSn solder thin film 15 (not depicted in FIG. 9), and the photodiode third AuSn solder thin film 16 (not depicted in FIG. 9). The AuSn solder thin film (for example, Au thin film: 80% and Sn thin film: 20%) is composed of an Au thin film and an Sn thin film and the total thickness of films is 3 micrometers. This film is formed by using the vacuum evaporation method and each pattern is formed by using the lift off method.

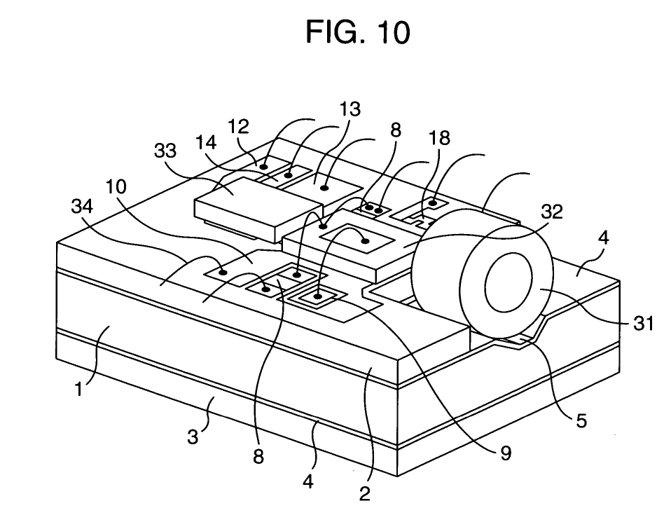

By successively performing the aforementioned steps, it is possible to obtain an optical bench for mounting an optical element according to the present invention. FIG. 10 schematically shows the state of the optical bench for mounting an optical element on which a laser diode 32, a photodiode 33, and an aspherical lens 31 are mounted. The aspherical lens 31 is fixed to the etched groove 5 by adhesive. The laser diode 32 and the photodiode 33 are fixed to the optical bench for mounting an optical element and more specifically, to the first glass substrate 2 by applying heat in order to melt the laser-diode AuSn solder thin film 11, the photodiode first AuSn solder thin film 17, the photodiode second AuSn solder thin film 15, and the photodiode third AuSn solder thin film 16. Here, the laser diode 32, the photodiode 33 and the aspherical lens 31 are fixed by passive alignment so that the optical axes of the laser diode 32, the photodiode 33, and the aspherical lens 31 are matched with one another. In order to match these axes, the following values are decided in advance: the width of the etched groove 5, the thickness of the first glass substrate 2, the position on the first glass substrate 2 on which the laser diode 32 is mounted, the position on the first glass substrate 2 on which the photodiode is mounted, and the position where the etched groove 5 is formed. In order to apply a high-frequency electric signal of 10 GHz or above to the optical bench, on which these optical parts are mounted, for mounting an optical element and transmit the optical signal outside, the respective parts are electrically connected by wire bonding. Since the high-frequency electric signal is handled, the length of each wire 34 for electrical connection is minimized by appropriately positioning the tantalum-nitride thin-film resistor 8, the tantalum-oxide thin-film capacitor 9, the laser-diode common thin-film electrode 10, the photodiode thin-film electrode 14, the photodiode first common thin-film electrode 12, the photodiode second common thin-film electrode 13, and the thin-film temperature sensor 18. Here, the tantalum-nitride thin-film resistor 8 functions to exclude damping of the electric signal and provides a terminal resistance. The electric signal is converted into an optical signal by the laser diode 32. The optical signal emitted from the laser diode 32 is transmitted via the aspherical lens 31 to outside such an optical fiber. Here, the optical signal emitted from the laser diode 32 is monitored by the photodiode 33. Here, a wiring in the optical bench for mounting an optical element and a wiring to out of the optical bench for mounting an optical element are shown by a wire 34 but the present invention is not limited to this. It is also possible to form a through hole in the optical bench for mounting an optical element and fill metal inside the hole to provide a via hole wiring for electrical connection of the respective elements. In this case, it is possible to correct the distortion of the waveform of the high-frequency signal caused by parasitic inductance of the wire 34.

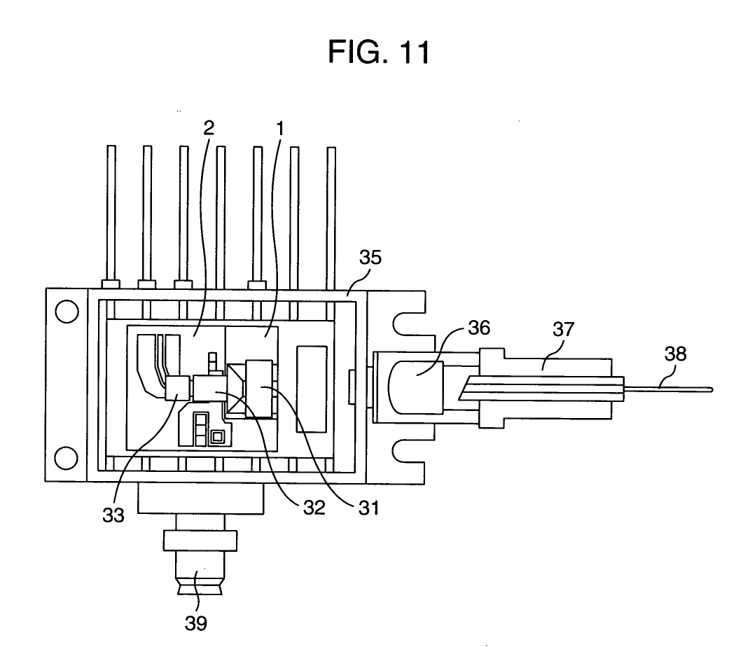

FIG. 11 schematically shows an optical bench for mounting an optical element shown in FIG. 1 mounted on a laser diode module of butterfly type. The laser diode 32 and the photodiode 33 are mounted on the first glass substrate 2. The aspherical lens 31 is mounted on the silicon substrate 1. The optical bench for mounting an optical element is mounted in a package 35. It should be noted that although not depicted, there is arranged a cooling Peltier element for suppressing heat generation of the laser diode at the lower portion of the optical bench for mounting an optical element. The high-frequency electric signal of 10 GHz or above is applied to the optical bench for mounting an optical element via a connector 39 having an excellent high-frequency characteristic. The optical signal from the laser diode 32 is transmitted outside via the aspherical lens 31, a collimator lens 36, and an optical fiber 38 fixed by a ferrule 37. With this configuration, the optical bench for mounting an optical element of the present invention is applied to the laser diode module.

An aqueous solution of potassium hydroxide is used for formation of the etched groove 5 and the inverse pyramid groove 6 for mounting the aspherical lens on the silicon substrate 1 constituting the optical bench for mounting an optical element thus explained. It is also possible to uses other etching solution capable of anisotropic etching of silicon such as TMAH (tetramethyl ammonium hydroxide) and EDP (ethylene diamin pyrocatecol water). However, from the viewpoint of the etched shape and handling, the aqueous solution of potassium hydroxide is most appropriate.

It should be further understood by those skilled in the art that although the foregoing description has been made on embodiments of the invention, the invention is not limited thereto and various changes and modifications may be made without departing from the spirit of the invention and the scope of the appended claims.

1. An optical bench for mounting an optical element comprising:
a first substrate including a lens or optical fiber mounting section, and
a second substrate, formed on a main surface of the first substrate, including a wiring layer having a mounting section of a laser diode optically coupled to the lens or the optical fiber and a coupling section electrically coupled to the laser diode, and having a higher resistivity than that of the first substrate.

2. An optical bench for mounting an optical element as claimed in claim 1, wherein the second substrate includes an opening in a region corresponding to the lens mounting section on the first substrate.

3. An optical bench for mounting an optical element comprising:
a first substrate including a lens mounting section,
a second substrate, formed opposite to one main surface of the first substrate, including a laser diode mounting section and a wiring layer coupled to the laser diode, and having a higher resistivity than that of the first substrate, and
a third substrate formed on another main surface which is the opposite side the aforementioned one main surface of the first substrate and having a higher resistivity than that of the first substrate.

4. An optical bench for mounting an optical element as claimed in claim 3, wherein the second substrate is a glass substrate.

5. An optical bench for mounting an optical element comprising:
a first substrate including a lens mounting section,
a laser diode mounting substrate, formed in a first region on one main surface of the first substrate, including a laser diode mounting section and a first wiring layer electrically coupled to the laser diode, and having a higher resistivity than that of the first substrate, and
a photodiode mounting substrate formed in a second region on the one main surface of the first substrate, including a photodiode mounting section and a second wiring layer electrically coupled to the photodiode, and having a higher resistivity than that of the first substrate.

6. An optical bench for mounting an optical element comprising:
a laser diode mounting substrate including a laser diode mounting section and a first wiring layer electrically coupled to the laser diode, and having a higher resistivity than that of a first substrate,
a first underlayer substrate which is formed on a surface opposite to the surface where the laser diode mounting section on the laser diode mounting substrate is formed and which includes a lens mounting section optically coupled to the laser diode,
a photodiode mounting substrate including a photodiode mounting section and a second wiring layer electrically coupled to the photodiode, and having a higher resistivity than that of the first substrate, and
a second underlayer substrate which is formed on a surface opposite to the surface where the photodiode mounting section is formed on the photodiode mounting substrate.

7. An optical bench for mounting an optical element comprising:
a semiconductor substrate including a lens or an optical fiber mounting section, and
a dielectric substrate, which is formed on one main surface of the semiconductor substrate, including a wiring layer having a mounting section of a laser diode optically coupled to the lens or the optical fiber and a coupling section for electrically coupled to the laser diode.

8. An optical bench for mounting an optical element comprising:
a first substrate including a lens mounting section,
a second substrate formed opposite to one main surface of the first substrate and including a laser diode mounting section and a wiring layer coupled to the laser diode, and
a third substrate formed on another main surface opposite to the one main surface of the first substrate.

9. A manufacturing method of an optical bench for mounting an optical element comprising the steps of:
forming a groove in a region where a lens or an optical fiber is arranged on one main surface of a first substrate, as a groove formation step,
bonding a second substrate onto the main surface of the first substrate where the groove is formed, as a bonding step,
forming an electrode film for electrically coupling to the laser diode on another main surface opposite to the bonded main surface of the second substrate and a wiring layer electrically coupled to the electrode film so that a wiring from outside is electrically coupled, as a conductor film formation step,
covering the film formed in the conductor film formation step with resist, as a resist formation step, and
patterning the resist to form an opening in a region corresponding to the groove formation region of the second substrate, as an opening formation step.
